(19) United States
(12) Patent Application Publication
(10) Pub. No.: US 2026/0177357 A1
(43) Pub. Date: Jun. 25, 2026

(54) MULTI-THREAT PROTECTIVE ARTICLE WITH A MULTI-LAYERED FABRIC COMPOSITE

(71) Applicant: Nano and Advanced Materials Institute Limited, Hong Kong (HK)

(72) Inventors: Kang ZHANG, Hong Kong (HK); Yuping CHANG, Hong Kong (HK); Shilong ZHANG, Hong Kong (HK); Christopher Cheung YEC, Hong Kong (HK); Jifan LI, Hong Kong (HK)

(21) Appl. No.: 19/000,578

(22) Filed: Dec. 23, 2024

(51) Int. Cl. F41H 5/04; A41D 31/24; A41D 31/28; B32B 5/12; B32B 5/18; B32B 5/24

(52) U.S. Cl. CPC F41H 5/0478; A41D 31/245; A41D 31/285; B32B 5/12; B32B 5/18; B32B 5/245; A41D 2500/52; B32B 2255/02; B32B 2264/10; B32B 2264/301; B32B 2307/546; B32B 2307/56; B32B 2307/7375; B32B 2571/02

(57) ABSTRACT

Traditional protective suits often struggle to balance puncture resistance with flexibility and comfort. Existing materials may provide protection but can be cumbersome or less effective under different threat conditions. This invention addresses these issues by employing a composite structure that leverages 2D fillers, 3D fabric configurations with auxetic performance, and a brick-and-mortar polymer compound to enhance both puncture resistance and energy absorption.

### FIELD OF THE INVENTION

The present invention generally relates to protective products, particularly those designed to provide resistance to punctures and other threats, including cutting, slashing, and impact.

### BACKGROUND OF THE INVENTION

Military, security personnel, and other high-risk workers need protective gear that can simultaneously defend against spikes, knives, and ballistic threats to enhance user safety in various high-risk scenarios. For instance, WO 01/37691A1 describes materials specifically engineered to provide protection against both knife attacks and ballistic threats. U.S. Pat. No. 6,133,169 discloses a knife, ice pick and ballistic penetration resistant structure comprising a metallic chain mail, tightly fabric layers and high tenacity ballistic resistant layers.

However, existing protective gear, despite offering multi-threat protection, has several common drawbacks. These include weight and comfort issues, as such armor is often bulky, leading to discomfort and restricted mobility, especially during prolonged wear. Many protective materials also lack breathability, causing users to overheat in high-temperature or high-intensity situations. Furthermore, flexibility is often sacrificed to enhance protective performance, limiting the wearer's agility in critical operations.

The balance of protection against multiple threats is another challenge, as some armor may excel in ballistic resistance but offer comparatively weaker protection against knives or spikes. High-performance protective gear is also typically expensive, making it unaffordable for some users or organizations, particularly when mass outfitting is required. These drawbacks highlight the need for improvement in current protective gear for certain applications.

### SUMMARY OF THE INVENTION

It is an objective of the present invention to provide a multi-threat protective article to solve the aforementioned technical problems. The layers are configured to maximize protection while maintaining flexibility and comfort. The garment is lightweight, durable, and suitable for prolonged use in various hostile environments.

This invention focuses on a type of protective fabric and/or composite material designed to enhance durability and mechanical performance. At the macro level, the material consists of multiple layers of fabric or composites. Some layers incorporate a negative Poisson's ratio structure to further improve the material's properties. By integrating exfoliated two-dimensional fillers into the polymeric materials, a brick-and-mortar microstructure is formed. This cohesive system works together to not only enhance the mechanical properties of the fabric and improve energy absorption, but also to achieve multi-threat protection without compromising comfort and flexibility.

In a first aspect, the present invention provides a multi-threat protective article with a multi-layered assembly. The multi-layered assembly includes an external hard coating layer for external protection; a negative Poisson's ratio fabric layer; a dense unidirectional fabric layer; and an inner foam layer positioned closest to a user's body for impact absorption. The negative Poisson's ratio fabric layer has raised strips or a sandwich structure with two faces partially unconnected, thereby forming a negative Poisson's ratio structure. The negative Poisson's ratio fabric layer and the dense unidirectional fabric layer are deposited between the external hard coating layer and the inner layer. Each layer of the multi-threat protective article has a stiffness ranging from 0.9N in the inner foam layer to 50N in the dense unidirectional fabric layer according to ASTM D4032-08.

In one embodiment, the multi-layered assembly is made from a fabric composite produced using a masterbatch, which includes an exfoliated two-dimensional filler being exfoliated and surface modified by a compatibilizer, and a polymeric material. The polymeric material is strengthened by the exfoliated two-dimensional filler to form a microstructure with each layer staggered relative to the adjacent layer. The exfoliated two-dimensional filler has a width of less than 10 μm and an aspect ratio of at least 50.

In one embodiment, the exfoliated two-dimensional filler is exfoliated and surface modified by the compatibilizer prior to blending with the polymeric material.

In one embodiment, the compatibilizer comprises polypropylene grafted maleic anhydride (PP-g-Ma), polyethylene grafted maleic anhydride (PE-g-Ma), ethylene-butyl acrylate grafted Methacrylate (EBA-g-Ma), poly(oligo(ethylene glycol) grafted methacrylate (POE-g-Ma), amino silane, or a combination thereof.

In one embodiment, the polymeric material includes polypropylene (PP), high density polyethylene (HDPE), ultrahigh molecular weight polyethylene (UHMWPE), polyamides (PA), polyurethane (PU), silicone rubber, or a combination thereof.

In one embodiment, the exfoliated two-dimensional filler includes clay, graphene, MXene, zirconium phosphate (ZrP), boron nitride (BN), molybdenum disulfide (MoS), layered double hydroxides (LDH), or a combination thereof.

In one embodiment, the negative Poisson's ratio fabric layer has a negative Poisson's ratio.

In one embodiment, the multi-layered fabric composite further contains a one-dimensional filler co-mixed with the exfoliated two-dimensional filler, promoting a parallel alignment of the exfoliated two-dimensional filler.

In one embodiment, the one-dimensional filler includes carbon nanotubes and carbon nanowires.

In one embodiment, the one-dimensional filler has a length greater than m.

In one embodiment, the carbon nanotubes include single-walled carbon nanotubes, multi-walled carbon nanotubes, functionalized carbon nanotubes, or doped carbon nanotubes.

In one embodiment, the carbon nanowires include graphene nanoribbons, carbon nanofibers.

In one embodiment, the fabric composite further includes a thixotropic agent comprising Thixatrol Plus, Thixatrol Max, Thixatrol ST, Thixatrol R, PE-WAX, PP-WAX, or a combination thereof.

In one embodiment, the multi-threat includes puncture-resistant, knife, and ballistic projectile penetration.

In a second aspect, the present invention provides a method for manufacturing a multi-threat protective article, including preparing a masterbatch, and forming a multi-layered fabric composite from the masterbatch. The masterbatch has an exfoliated two-dimensional filler that is exfoliated and surface modified by a compatibilizer, and a polymeric material. The multi-layered fabric composite is sequentially deposited from the inside out to include: an inner foam layer, a dense unidirectional fabric layer, and an external hard coating layer. The exfoliated two-dimensional filler has a width of less than 10 m and an aspect ratio of at least 50.

In one embodiment, the exfoliated two-dimensional filler is blended with the polymeric material to form a microstructure with each layer staggered relative to the adjacent layer.

In one embodiment, the method further comprising co-mixing a one-dimensional filler with the exfoliated two-dimensional filler.

In one embodiment, the method further includes incorporating a thixotropic agent into the masterbatch.

### BRIEF DESCRIPTION OF THE DRAWINGS

Embodiments of the invention are described in more details hereinafter with reference to the drawings, in which:

FIG. 1 shows a schematic diagram of the protective garment, with the enlarged area displaying the structure of each layer;

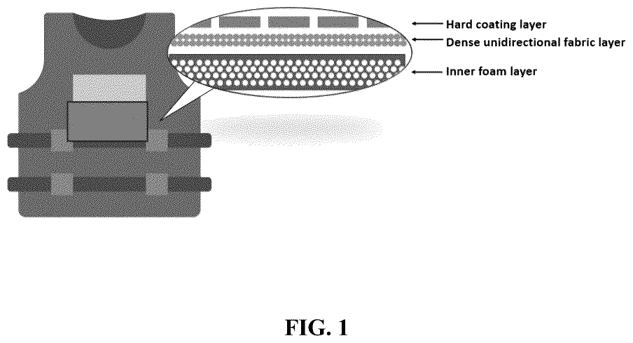

FIG. 2A shows a schematic diagram of a layer with raised strips and a fabric substrate. FIG. 2B shows a schematic diagram of a negative Poisson's ratio fabric layer;

FIG. 3A shows a conventional method for exfoliating and modifying two-dimensional (2D) fillers. FIG. 3B shows the present method for exfoliating and modifying the 2D fillers;

FIG. 4A shows a schematic diagram of a side view of a fiber-polymer matrix with brick-and-motar structure, and FIG. 4B shows its top view;

FIG. 5A and FIG. 5B show the exfoliated 2D fillers with different aspect ratios, which will alter the width of the 2D fillers;

FIG. 6 shows a schematic diagram of a fiber-polymer matrix, in which the 2D fillers is co-mixed with one-dimensional (1D) fillers;

FIG. 7 shows the preparation process of the masterbatch;

FIG. 8A shows the three-layer structure of the multi-layered fabric composite. FIG. 8B shows the four-layer structure of the multi-layered fabric composite;

FIG. 9A shows the setup for the stab test. FIG. 9B shows knife stabbing tests on layered 75 gsm unidirectional fabric (61 plies) with penetration depths <3 mm in all three strikes;

FIG. 10 shows impact resistance test result of the unidirectional fabric+foam combination, having a deformation depth <9 mm; and

FIG. 11 shows the stiffness of different plies of 75 gsm unidirectional fabric.

### DETAILED DESCRIPTION

In the following description, masterbatch, toughen fibers, multi-threat protective articles are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention provides a multi-threat protective article comprising multiple layers, each constructed from a multi-threat resistant fabric composite. The composite is made from a masterbatch, which includes an exfoliated two-dimensional filler, which is surface modified by a compatibilizer and blended with a polymeric material. This configuration forms a brick-and-mortar microstructure within the fiber-polymer matrix, enhancing the material's resistance to various threats.

The polymeric material may include various types of polymers, which can be selected based on their mechanical properties, compatibility with the fillers, and intended application. Examples of suitable polymeric material include, but are not limited to, polypropylene (PP), high density polyethylene (HDPE), ultrahigh molecular weight polyethylene (UHMWPE), polyamides (PA), polyurethane (PU, including PU foam and PU casting rigid plate), silicone rubber, or a combination thereof.

In one embodiment, the article includes at least three layers, arranged sequentially from the outermost to the innermost: a hard coating layer, a dense unidirectional fabric layer, and an inner layer. The hard coating layer is made of casting PU rigid plate. The dense unidirectional fabric layer is made of PP, HDPE, UHMWPE, nylon, or their mixture thereof. The inner layer is made of HDPE, silicone rubber, and Pu foam.

Additionally, the article includes at least four layers, arranged sequentially from the outermost to the innermost: a hard coating layer, a dense unidirectional fabric layer, a negative Poisson's ratio fabric layer and an inner layer.

Without limitation, the article of the present invention may include five or more than five layers. For instance, it may comprise a hard coating layer, a dense unidirectional fabric layer, a negative Poisson's ratio fabric layer, an inner layer, and additional functional layers such as a cushioning layer, an insulating layer, or other layers designed to enhance protective performance. These layers can be combined and arranged according to specific application requirements to achieve optimal multi-threat protection.

In one embodiment, the negative Poisson's ratio fabric layer can be formed with multiple plies of woven or knitted fabrics. In particular, the negative Poisson's ratio fabric layer features no less than 2 plies of fabrics, each with raised strips or a sandwich structure, overlapping in misalignment when stacked. The inclusion of the raised strips or the sandwich structure, offset from each other in adjacent layers, contributes to the auxetic property.

In one embodiment, the inner layer is cushion foam.

The invention also features the inclusion of raised strips or a sandwich structure within the layer, creating a negative Poisson's ratio structure that improves both flexibility and toughness. The inclusion of a sandwich structure with raised strips enhances the material's auxetic properties. When subjected to deformation, this structure creates additional points of energy dissipation, further increasing the protective capabilities of the fabric.

The Poisson's ratio of a material is a measure of the material's deformation in the perpendicular direction when stretched or compressed. For most materials, when they are stretched in one direction, they contract in the perpendicular direction, resulting in a positive Poisson's ratio. Conversely, when compressed, they expand laterally. However, materials exhibit a negative Poisson's ratio, meaning that when they are stretched, they expand laterally, and when compressed, they contract laterally.

The integration of materials with a negative Poisson's ratio in protective fabrics offers several key advantages, particularly in enhancing impact resistance, flexibility, and energy absorption. These properties are crucial in high-performance protective gear designed to withstand various threats such as punctures, ballistic impacts, and slashing.

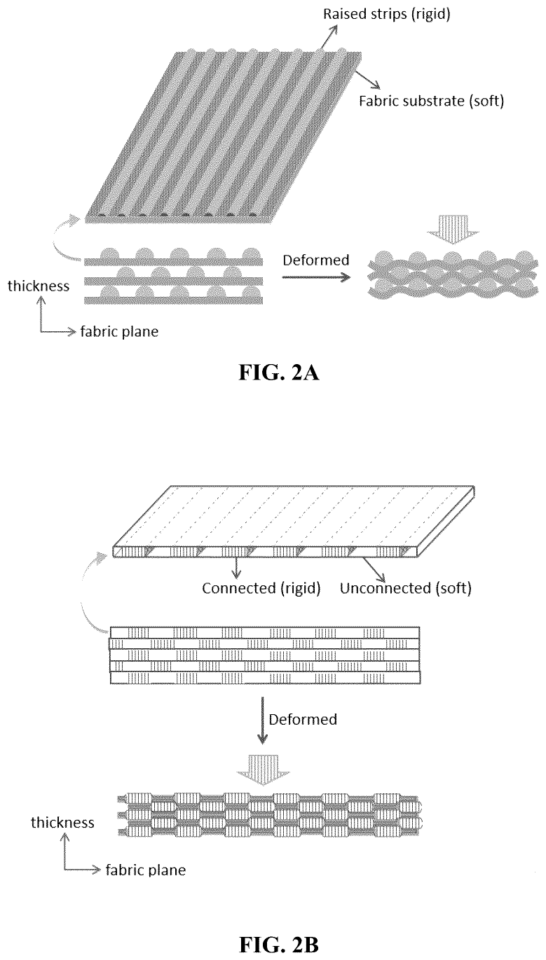

As shown in FIG. 2A, the multiple layers contain one or more raised strips that extend vertically. These raised strips reinforce the structural integrity of the layers, offering additional strength and potentially inducing a negative Poisson's ratio effect, which enhances the material's capacity to absorb and dissipate impact energy. Upon deformation, each layer closely conforms to the others, ensuring a tight and cohesive fit. FIG. 2B depicts another embodiment featuring a sandwich structure, where the raised strips are arranged in an alternating pattern. Upon deformation, the unconnected sections of the raised strips conform to the connected sections in adjacent layers, resulting in the auxetic effect.

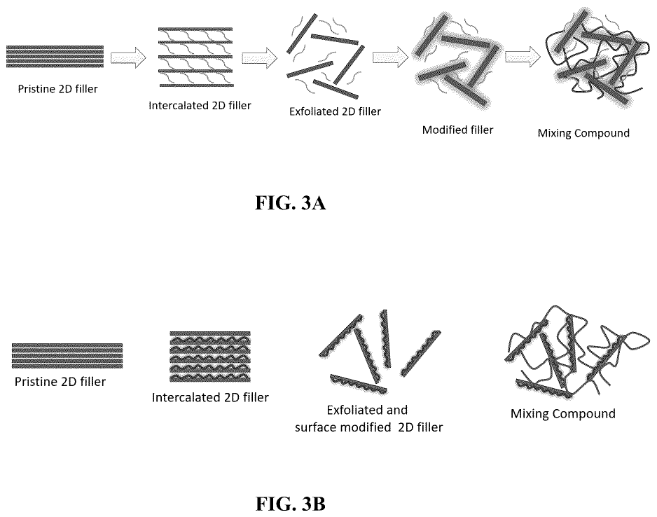

The fabric composite of the present invention includes exfoliated 2D fillers that have been surface-modified using a compatibilizer. The compatibilizer facilitates effective integration with the polymeric material, creating a uniform mixture that assembles into a brick-and-mortar microstructure. FIG. 3A shows a conventional one-step process for exfoliating and surface-modifying the fillers. In traditional methods for treating 2D fillers, particles must be intercalated and exfoliated to expose the inner surfaces of the plate particles before surface modification can be performed. However, this approach has several drawbacks. One significant limitation is the incomplete or inconsistent exfoliation of the fillers, leading to suboptimal exposure of the inner surfaces. This can result in uneven surface modification, which may affect the overall performance of the composite material. Additionally, the simultaneous execution of exfoliation and surface modification can lead to insufficient control over the degree of modification, reducing the efficiency of the compatibilizer and potentially compromising the uniformity of the resulting brick-and-mortar microstructure.

Therefore, as shown in FIG. 3B, the present invention demonstrates that the compatibilizer can serve as both an intercalation agent and a surface modification agent. This processing method not only simplifies the pre-treatment procedure but also avoids the negative effects associated with intercalated small molecules. Additionally, this approach offers several other advantages, including improved dispersion of fillers within the polymer matrix, enhanced compatibility between the fillers and the matrix, and increased interfacial bonding strength, leading to superior overall performance of the composite material. Furthermore, the method reduces processing complexity, which not only minimizes the number of steps involved but also decreases energy consumption and processing time, making the material easier to manufacture.

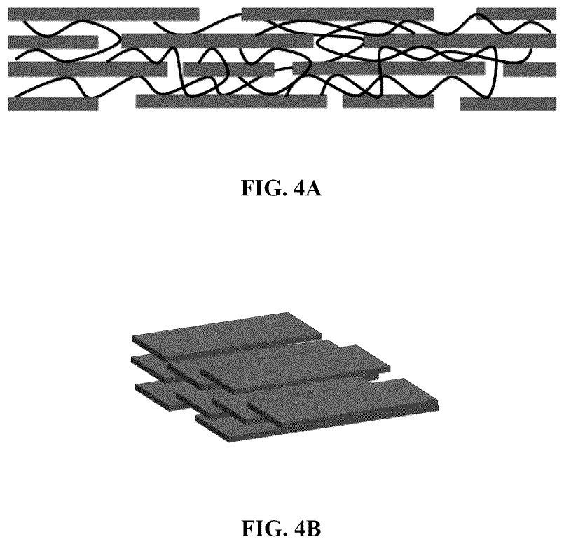

This microstructure plays a crucial role in improving the material's mechanical properties and providing resistance to various types of threats. FIG. 4A shows the brick-and-mortar configuration within the fiber-polymer matrix, while FIG. 4B displays a top view thereof.

Examples of the two-dimensional fillers may include, but are not limited to, clay, graphene, boron nitride (BN), molybdenum disulfide (MoS), MXene, zirconium phosphate (ZrP) and layered double hydroxides (LDH). These fillers may be used alone or in combination, depending on the specific requirements of the protective article.

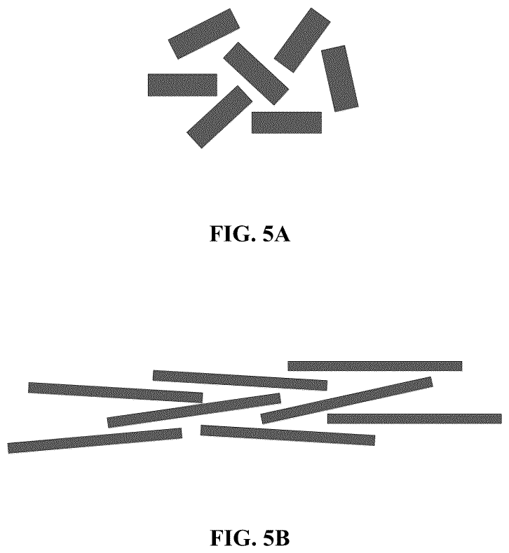

For 2D fillers with a small aspect ratio, the particles tend to be randomly dispersed within the polymer matrix (FIG. 5A). In contrast, 2D fillers with a large aspect ratio are more likely to align parallelly within the polymer matrix due to the collision and flipping of the plate-like particles during the compounding process (FIG. 5B). The exfoliated 2D filler has a width of less than 10 μm and an aspect ratio (the ratio of width to thickness) greater than 50. Preferably, the exfoliated 2D filler has the aspect ratio ranging from 50 to 1000.

Controlling the aspect ratio of 2D fillers is advantageous because a larger aspect ratio enhances the alignment of the fillers within the matrix, which can significantly improve the mechanical properties, such as tensile strength and barrier performance. This alignment also contributes to more efficient stress transfer between the polymer matrix and the fillers, resulting in a composite material with superior structural integrity and overall performance.

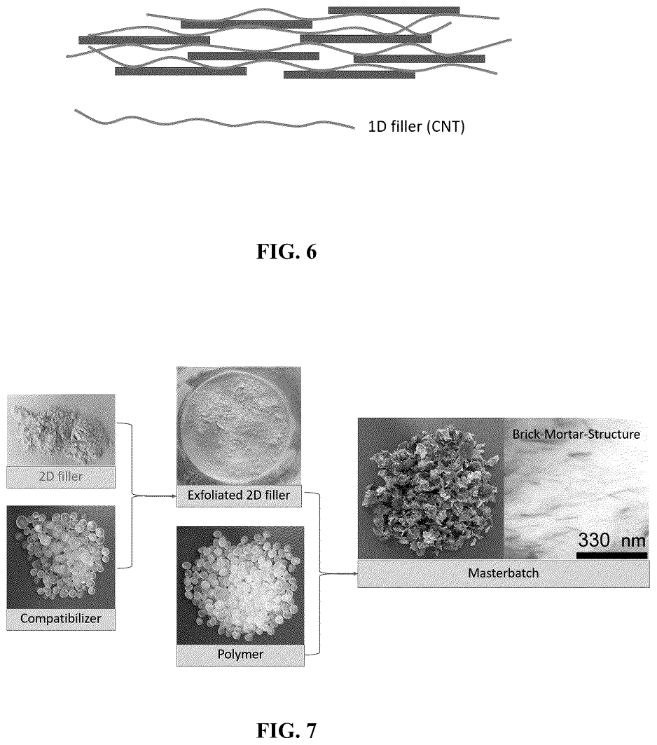

Moreover, the fabric composite of the present invention also features specific 2D fillers (with larger aspect ratio) combined with 1D fillers like carbon nanotubes and nanowires to further improve its protective capabilities (FIG. 6).

The addition of 1D fillers offers several advantages, including enhanced mechanical strength and toughness, as the 1D fillers can bridge microcracks and distribute stress more effectively throughout the composite. This synergistic combination of 2D and 1D fillers creates a reinforced network within the polymer matrix, which not only increases the composite's resistance to puncture and tearing but also improves its overall durability and longevity, making it highly suitable for protective applications.

During the compounding and post-tensioning of the fiber composite, the tensile forces exerted on the 1D fillers can induce a parallel alignment of the 2D fillers, thereby promoting a more effective filler dispersion network and enhancing the overall performance of the composite.

Suitable 1D fillers, including carbon nanotubes (CNT) and carbon nanowires, are selected for their ability to significantly improve the composite's strength and impact resistance. The length of these 1D fillers (e.g., CNT) is substantially greater than the width of the 2D fillers, with the 1D fillers typically having a length exceeding 20 m to ensure sufficient reinforcement.

The 1D filler and the 2D filler can form a 1D-2D filler dispersion network through several mechanisms during the fabrication process:

(1) Melt blending/extrusion: during melt blending or extrusion, both 1D and 2D fillers are mixed with a polymer matrix. The 1D fillers are dispersed throughout the polymer matrix. The shear forces during processing help to distribute the 1D fillers and align them in parallel. At the same time, the 2D fillers are also dispersed and tend to align in a planar orientation.

(2) Stretching: post-stretching of the polymer composite can further align the 1D fillers parallel to the stretching direction. As the polymer matrix is stretched, the 2D fillers may also align parallel to the 1D fillers, leading to a well-organized network.

Optionally, the composite may also include a thixotropic agent to further improve the material's rheological properties, ensuring ease of processing and application during manufacturing. Examples of the thixotropic agent may include Thixatrol Plus, Thixatrol Max, Thixatrol ST, Thixatrol R, PE-WAX, PP-WAX and their mixture thereof.

### EXAMPLE

### Example 1

### Preparation of the Fabric Composite

First, a specific amount of compatibilizer is selected. The compatibilizer acts as both an intercalating agent and a surface modifier for the 2D fillers. 5 g of montmorillonite (MMT) is added to 150 g of xylene. The mixture is subjected to ultrasonication or high-shear mixing for 1 hour to achieve well dispersion. 25 g of polypropylene grafted maleic anhydride (PP-g-Ma) is added to the mixture. The mixture is subjected to magnetic stirring at 125° C. for 6 h to achieved thoroughly dissolving of PP-g-Ma and uniform mixing. The mixture is added to equal amount of ethanol then centrifuged. The sediment is washed by ethanol three times to eliminate the excess xylene. Then the sediment is dried in 80° C. oven for overnight to obtain MMT/PP-g-Ma compound.

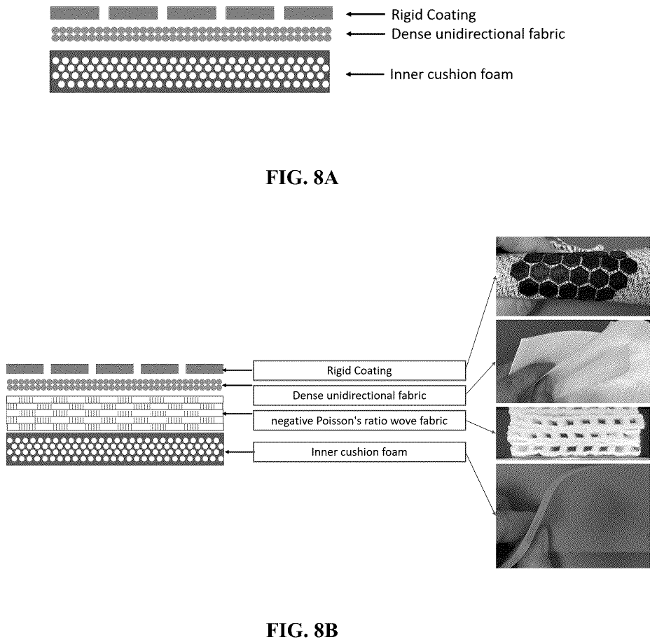

The exfoliated and surface-modified MMT (5 g MMT and 25 g PP-g-Ma) are then blended with 75 g of PP by internal mixer at 180° C., 100 rpm for 30 min to form a masterbatch, as shown in FIG. 7. The ratio between the 2D fillers and the polymeric material is 5:100. During this high temperature mixing process, the compatibilizer molecules (PP-g-Ma) intercalate between the layers of the MMT, leading to their separation into individual sheets. Simultaneously, the compatibilizer modifies the surface of the exfoliated 2D sheets, enhancing their compatibility with the polymer matrix and promoting better dispersion within the matrix. As the exfoliated 2D fillers are mixed into the polymer matrix, they naturally align in a layered manner, forming discrete, plate-like structures within the matrix. The polymer matrix, acting as the “mortar,” fills the spaces between these plate-like 2D fillers, which function as the “bricks”. The resulting brick-and-mortar microstructure within the polymer matrix significantly enhances puncture resistance and overall toughness.

Once the brick-and-mortar structure is formed within the polymer matrix, the masterbatch may undergo further melt spinning into toughened fiber.

The aforementioned is added to melt spinning machine to obtained toughness fiber, the spinning temperature is 220° C., 15 rpm, the wind speed is 50 rpm.

In control experiment, 5 g MMT is directly mixed with 25 g PP-g-Ma by internal mixer at 180° C., 100 rpm for 30 min, but the PP-g-Ma can't be intercalated into the layer of MMT. Only if the ratio of PP-g-Ma to MMT raises to above 25:1, the PP-g-Ma can be intercalated into MMT interlayer by this directly mixing method. However, excessive PP-g-Ma is harmful to the mechanical properties of PP composites.

### Example 2

### Structural Configuration of Multiple Layers

The multi-threat protective article consists of multiple layers, each strategically designed to maximize protection against different threats while ensuring flexibility and comfort.

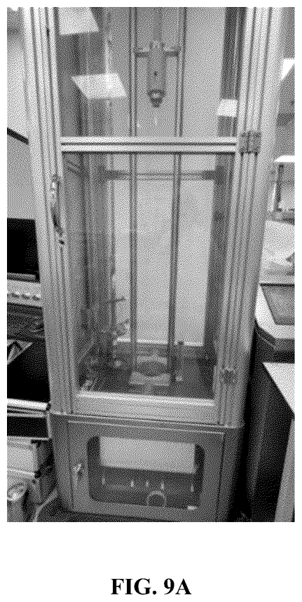

In one embodiment, the article includes at least three layers, arranged sequentially from the outermost to the innermost: a hard coating layer, a dense unidirectional fabric layer, and an inner layer (FIG. 8A). The hard coating layer provides initial resistance against sharp and high-velocity impacts, while the dense unidirectional fabric layer contributes to the overall tensile strength and tear resistance of the article. The inner foam layer, positioned closest to the user's body, offers cushioning and impact absorption, ensuring comfort during prolonged use.

In another embodiment, the article includes at least four layers, arranged sequentially from the outermost to the innermost: a hard coating layer, a dense unidirectional fabric layer, a negative Poisson's ratio fabric layer, and an inner layer (FIG. 8B). The fabrics with raising strips or a sandwich structure in the negative Poisson's ratio fabric layer are connected by an adhesive, to ensure their offset alignment, while no connection exists between the negative Poisson's ratio fabric layer with adjacent layers or between any other layers.

### Example 3

### Characterization of the Multi-Layered Fabric Composite

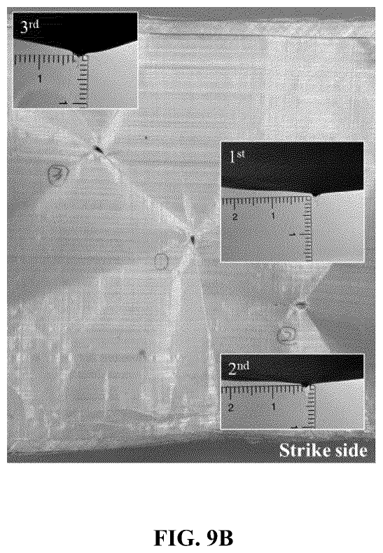

Stab testing is conducted according to the KR1 and SP1 level in 2017 CAST Home Office Body Armour Standard. Testing involves layered 75 gsm and 120 gsm unidirectional fabric under conditions simulating realistic stab threats. Spike stabbing tests yield additional performance insights, summarized in Table 1. The setup for the stab test is illustrated in FIG. 9A.

During knife stab testing on 61 plies of the 75 gsm unidirectional fabric, the penetration depths in all three strikes were consistently less than 3 mm, as seen in FIG. 9B.

TABLE 1
Spike stabbing test results of layered unidirectional fabric

| | Thickness | No. of | Penetration Depth (mm) | | | |
|---|---|---|---|---|---|---|
| Material | (mm)/ply | ply | 1^{st} | 2^{nd} | 3^{rd} | 4^{th} |
| 75 gsm | 0.1 | 66 | ≈9 | <1 | 0 | 0 |
| unidirectional | | | | | | |
| fabric | | | | | | |
| 120 gsm | 0.2 | 41 | 0 | 0 | ≈3 | 0 |
| unidirectional | | | | | | |
| fabric | | | | | | |

For the 75 gsm unidirectional fabric (0.1 mm thickness per ply, 66 plies), the penetration depth for the first strike is approximately 9 mm, followed by depths of less than 1 mm, 0 mm, and 0 mm in subsequent strikes. The 120 gsm unidirectional fabric (0.2 mm thickness per ply, 41 plies) demonstrates even greater resistance, with the first and second strikes showing 0 mm penetration and the third strike at approximately 3 mm. Combined testing with unidirectional fabric and foam layers further enhances performance, particularly in spike tests, where no penetration is observed across multiple angles and strikes (Table 2).

TABLE 2
Stab test results of the unidirectional fabric + foam combination

| The n^{th} test | Knife | Spike |
|---|---|---|
| (strike angle) | stabbing | stabbing |
| 1^{st} (30°) | Penetrated through, cut | Not penetrated |
| | length in the bottom | through, PD = 0 |
| | foam layer ≈ 3 mm, PD | |
| | estimate 3 × 2.396 = | |
| | 7.188 mm | |
| 2^{nd} (45°) | Not penetrated | Not penetrated |
| | through, PD = 0 | through, PD = 0 |
| 3^{rd} (60°) | Not penetrated | Not penetrated |
| | through, PD = 0 | through, PD = 0 |
| 4^{th} (90°) | Not penetrated | Not penetrated |
| | through, PD = 0 | through, PD = 0 |

*Strike angle is only applicable to the knife stabbing test;
*PD is short for Penetration Depth (mm).

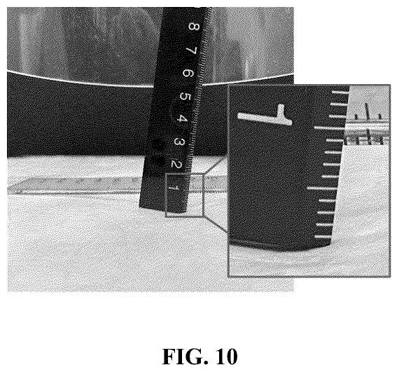

Impact resistance testing, conducted per the W5 level in the VPAM KDIW 2004 standard, demonstrates deformation depths of less than 9 mm for the unidirectional fabric and foam combination, as depicted in FIG. 10.

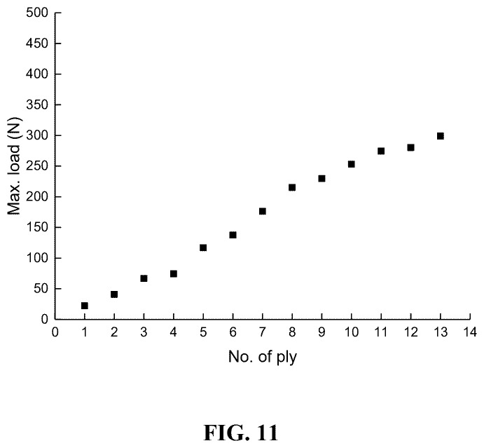

Additionally, stiffness testing, according to ASTM D4032, assesses the force required for fabric bending, as shown in FIG. 11, providing a comprehensive profile of the composite's structural resilience and flexibility, ideal for multi-threat protective applications.

### Example 4

### Application of the Multilayer Fabric Composite in Multi-Threat Protective Articles

The multi-layered fabric composite is designed for incorporation into protective articles that safeguard against diverse threat types, including knife and spike attacks.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The “brick-and-mortar structure” refers to a material arrangement where alternating layers mimic the organization of bricks and mortar in construction. In this structure, stiff, hard layers (“bricks”) are interspersed with softer, more flexible layers (“mortar”). This configuration enhances mechanical properties, such as toughness and strength, by combining rigidity with the ability to absorb and distribute stress, reducing the likelihood of fracture.

The term “negative Poisson's ratio” refers to a property of materials where the lateral strain is in the opposite direction to the applied axial strain. In other words, when a material with NPR is stretched in one direction, it expands in the other direction, and when compressed, it contracts laterally.

A “thixotropic agent” is a substance that is added to a material to impart thixotropy, which is a property where the material becomes less viscous when subjected to shear forces, such as stirring or shaking, and returns to a more viscous state when at rest. This behavior allows for easier processing and application during manufacturing, as the material can flow more freely when being worked with but maintain its shape and stability once the forces are removed.

Ther term “MXene” refers to a class of two-dimensional inorganic compounds, that consist of atomically thin layers of transition metal carbides, nitrides, or carbonitrides. MXenes accept a variety of hydrophilic terminations.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. A multi-threat protective article with a multi-layered assembly, wherein the multi-layered assembly comprises:
an external hard coating layer for external protection;
a negative Poisson's ratio fabric layer, the negative Poisson's ratio fabric layer has raised strips or a sandwich structure with two faces partially unconnected, thereby forming a negative Poisson's ratio structure;
a dense unidirectional fabric layer; and
an inner foam layer positioned closest to a user's body for impact absorption,
wherein the negative Poisson's ratio fabric layer and the dense unidirectional fabric layer are deposited between the external hard coating layer and the inner layer,
wherein each layer of the multi-threat protective article has a stiffness ranging from 0.9N in the inner foam layer to 50N in the dense unidirectional fabric layer according to ASTM D4032-08.

2. The multi-threat protective article of claim 1, wherein the multi-layered assembly is made from a fabric composite produced using a masterbatch comprising:
an exfoliated two-dimensional filler being exfoliated and surface modified by a compatibilizer; and
a polymeric material, wherein the polymeric material is strengthened by the exfoliated two-dimensional filler to form a microstructure with each layer staggered relative to the adjacent layer,
wherein the exfoliated two-dimensional filler has a width of less than 10 μm and an aspect ratio of at least 50.

3. The multi-threat protective article of claim 2, wherein the exfoliated two-dimensional filler is exfoliated and surface modified by the compatibilizer prior to blending with the polymeric material.

4. The multi-threat protective article of claim 2, wherein the compatibilizer comprises polypropylene grafted maleic anhydride (PP-g-Ma), polyethylene grafted maleic anhydride (PE-g-Ma), ethylene-butyl acrylate grafted Methacrylate (EBA-g-Ma), poly(oligo(ethylene glycol) grafted methacrylate (POE-g-Ma), amino silane, or a combination thereof.

5. The multi-threat protective article of claim 2, wherein the polymeric material comprises polypropylene (PP), high density polyethylene (HDPE), ultrahigh molecular weight polyethylene (UHMWPE), polyamides (PA), polyurethane (PU), silicone rubber, or a combination thereof.

6. The multi-threat protective article of claim 1, wherein the exfoliated two-dimensional filler comprises clay, graphene, MXene, zirconium phosphate (ZrP), boron nitride (BN), molybdenum disulfide (MoS), layered double hydroxides (LDH), or a combination thereof.

7. The multi-threat protective article of claim 1, wherein the negative Poisson's ratio fabric layer has a negative Poisson's ratio.

8. The multi-threat protective article of claim 1, wherein the multi-layered fabric composite further comprises a one-dimensional filler co-mixed with the exfoliated two-dimensional filler, promoting a parallel alignment of the exfoliated two-dimensional filler.

9. The multi-threat protective article of claim 8, wherein the one-dimensional filler comprises carbon nanotubes and carbon nanowires.

10. The multi-threat protective article of claim 9, wherein the one-dimensional filler has a length greater than 20 μm.

11. The multi-threat protective article of claim 9, wherein the carbon nanotubes comprise single-walled carbon nanotubes, multi-walled carbon nanotubes, functionalized carbon nanotubes, or doped carbon nanotubes.

12. The multi-threat protective article of claim 9, wherein the carbon nanowires comprise graphene nanoribbons, carbon nanofibers.

13. The multi-threat protective article of claim 2, wherein the fabric composite further comprises a thixotropic agent comprising Thixatrol Plus, Thixatrol Max, Thixatrol ST, Thixatrol R, PE-WAX, PP-WAX, or a combination thereof.

14. The multi-threat protective article of claim 1, wherein the multi-threat comprises puncture-resistant, knife, and ballistic projectile penetration.

15. A method for manufacturing a multi-threat protective article, comprising:
preparing a masterbatch, wherein the masterbatch comprises an exfoliated two-dimensional filler that is exfoliated and surface modified by a compatibilizer, and a polymeric material;
forming a multi-layered fabric composite from the masterbatch, wherein the multi-layered fabric composite is sequentially deposited from the inside out to include: an inner foam layer, a dense unidirectional fabric layer, and an external hard coating layer,
wherein the exfoliated two-dimensional filler has a width of less than 10 μm and an aspect ratio of at least 50.

16. The method of claim 15, wherein the exfoliated two-dimensional filler is blended with the polymeric material to form a microstructure with each layer staggered relative to the adjacent layer.

17. The method of claim 15, wherein the method further comprising co-mixing a one-dimensional filler with the exfoliated two-dimensional filler.

18. The method of claim 15, wherein the method further comprising incorporating a thixotropic agent into the masterbatch.
